(19) United States
(12) Patent Application Publication
(10) Pub. No.: US 2022/0073217 A1
(43) Pub. Date: Mar. 10, 2022

(54) DYNAMIC RADIATIVE THERMAL MANAGEMENT OF SPACECRAFT

(71) Applicants: Brigham Young University (BYU), Provo, UT (US); University of Dayton Technology Partnerships Office (UDTPO), Dayton, OH (US)

(72) Inventors: Brian D. Iverson, Provo, UT (US); Rydge B. Mulford, Dayton, OH (US); Matthew R. Jones, Provo, UT (US)

(21) Appl. No.: 17/447,358

(22) Filed: Sep. 10, 2021

Related U.S. Application Data
(60) Provisional application No. 63/076,812, filed on Sep. 10, 2020.

(51) Int. Cl. B64G 1/50

(52) U.S. Cl. CPC B64G 1/503; B64G 1/222

(57) ABSTRACT

A method includes coupling a radiator panel assembly to a component, and conducting heat from the component via a thermally conductive hinge into at least one base radiator panel in the radiator panel assembly. The method further includes placing the at least one base radiator panel in a position to radiate a fraction of the heat into space through a surface of the at least one base radiator panel, and dynamically varying the position of the at least one base radiator panel to vary an amount of heat loss through the at least one base radiator panel to regulate a temperature of the component.

### CROSS-REFERENCE TO RELATED APPLICATION

This application claims priority to, and the benefit, under 35 U.S.C. § 119, of U.S. Provisional Patent Application No. 63/076,812, filed on Sep. 10, 2020, entitled “Origami Radiator,” which is incorporated by reference in its entirety herein.

### STATEMENT REGARDING FEDERALLY SPONSORED RESEARCH

This invention was made with government support under NSF Grant No. 1749395, funded by the National Science Foundation, and under NASA Space Technology Research Fellowship grant No.NNX15AP49H, funded by National Aeronautics and Space Administration. The government has certain rights in the invention.

### TECHNICAL FIELD

The present disclosure relates to thermal management of systems where radiation is a dominant mode of heat transfer, whether in terrestrial or extraterrestrial applications. The managed systems include instrument containers in vacuum or space environments, and in particular, to temperature regulation of spacecraft components.

### BACKGROUND

All spacecraft components have a range of allowable operating temperatures that must be maintained in order to meet survival and operational (function/performance) requirements at all times. If the spacecraft is overheated, the spacecraft components can fail or malfunction. Excess waste heat created on the spacecraft is rejected to space by the use of radiators.

### SUMMARY

In a general aspect, a method includes coupling a radiator panel assembly to a component, and conducting heat from the component via a thermally conductive hinge into at least one base radiator panel in the radiator panel assembly. The method further includes placing the at least one base radiator panel in a position to radiate a fraction of the heat into space through a surface of the at least one base radiator panel, and dynamically varying the position of the at least one base radiator panel to vary an amount of heat loss through the at least one base radiator panel to regulate a temperature of the component.

In a general aspect, a thermal management system includes a foldable multi-panel radiator assembly thermally coupled to a component subjected to varying waste heat loads. The foldable multi-panel radiator assembly includes a multiplicity of radiator panels with each radiator panel connected in series or parallel to a neighboring radiator panel by a thermally-conductive hinge. The thermal management system further includes an actuation mechanism configured to fold, partially unfold, or fully unfold the foldable multi-panel radiator assembly to remove the varying waste heat loads through the radiator assembly.

In a general aspect, a spacecraft unit includes a container containing one or more heat generating instruments. The container is coupled to a foldable radiator assembly including one or more base radiator panels. The one or more base radiator panels forming a complete tessellation of a surface in a folded state of the foldable radiator assembly. In a further aspect, the space craft unit includes at least one bi-metallic temperature-responsive positioner coupling at least one of the base radiator panels to the container. The at least one bi-metallic temperature-responsive positioner is configured to unfold the at least one of the base radiator panel in response to a change in temperature of the container.

### BRIEF DESCRIPTION OF THE DRAWINGS

FIG. 1A, FIG. 1B, and FIG. 1C are schematic illustrations, in cross sectional views, of an example foldable multi-panel radiator assembly.

FIG. 2 is schematic illustration, in perspective view, of another example foldable multi-panel radiator assembly.

FIG. 3 illustrates an example actuation mechanism that can be integrated with the radiator assembly of FIG. 2.

FIG. 4 is schematic illustration of the multi-panel radiator assembly of FIG. 2 integrated with the actuation mechanism of FIG. 3.

FIG. 5A and FIG. 5B illustrate, in perspective views, a foldable multi-panel radiator assembly disposed on or in a spacecraft container.

FIG. 6 illustrates a method for regulating temperatures of a component on a spacecraft.

Like reference symbols in the various drawings indicate like and/or similar elements. The drawings are presented only for purposes of illustration and may not necessarily be to scale. Also, in some views, one or more features of an implementation may be obscured or omitted in a drawing.

### DETAILED DESCRIPTION

Systems and methods for actively-controlled and passively-controlled radiative cooling of an instrument enclosure (such as a spacecraft container) are described herein. The systems and methods can be used toward maintaining a steady state temperature and/or to modulate heat rejection of a spacecraft component subjected to varying waste heat loads.

A disclosed thermal management system includes a collapsible single-panel or multi-panel radiator assembly that may be coupled, for example, via thermal conduction to the spacecraft component subjected to varying waste heat loads.

An example foldable radiator assembly includes either a single radiator panel or a multiplicity of radiator panels. Single (i.e., individual) radiator panels may be operated independently (i.e. in a parallel manner) when the multiple radiator panels are not connected in series. The radiator panels may be connected to the system to be cooled or to other panels in series using rotational or compliant (e.g. flexible), thermally-conductive joints or hinges (including, e.g., rotating hinges, flexible metal straps, flexible heat pipes, rotating fluid joints, flexible carbon sheets, etc.). The thermally-conductive joints or hinges may be made of flexible material or of moving components.

The radiator panels in the assembly can be actuated (i.e., folded or un-folded) by an actuation mechanism to present the radiator panel surfaces in different positions and orientations. The different positions and orientations anywhere in between and including a fully stowed and a fully deployed position can correspond to different radiative cooling power states of the radiator assembly.

In a fully folded or contracted configuration (also can be referred to as a stowed configuration), the foldable radiator assembly may be in a minimum (or reduced) radiative cooling power state. In a fully un-folded or expanded configuration, the foldable radiator assembly may be in a maximum radiative cooling power state. A turn-down ratio (e.g., equal to maximum radiative cooling power/minimum radiative cooling power) can be a useful metric to characterize an operational cooling power range or capacity of the foldable radiator assembly.

The disclosed thermal management system may include a feedback controller circuit or loop to drive the actuation mechanism to position the foldable radiator assembly in different radiative cooling power states. In example implementations, the feedback controller circuit may be a proportional-integral-derivative (PID) circuit. The feedback controller circuit or loop may position (i.e., fold or unfold) the foldable radiator assembly to obtain the radiative cooling power needed to balance the waste heat load and maintain a steady state temperature of the spacecraft component.

The disclosed thermal management system may include a passive (i.e. not externally powered) feedback control mechanism (e.g., bi-metallic strips or coils, shape memory alloys, or other temperature-responsive positioning actuators, etc.) to actuate panel positions of the foldable radiator assembly in different radiative cooling power states. The actuation mechanism may position (i.e., fold or unfold) the foldable radiator assembly to obtain the radiative cooling power needed to balance the waste heat load and maintain a steady state temperature of the spacecraft component.

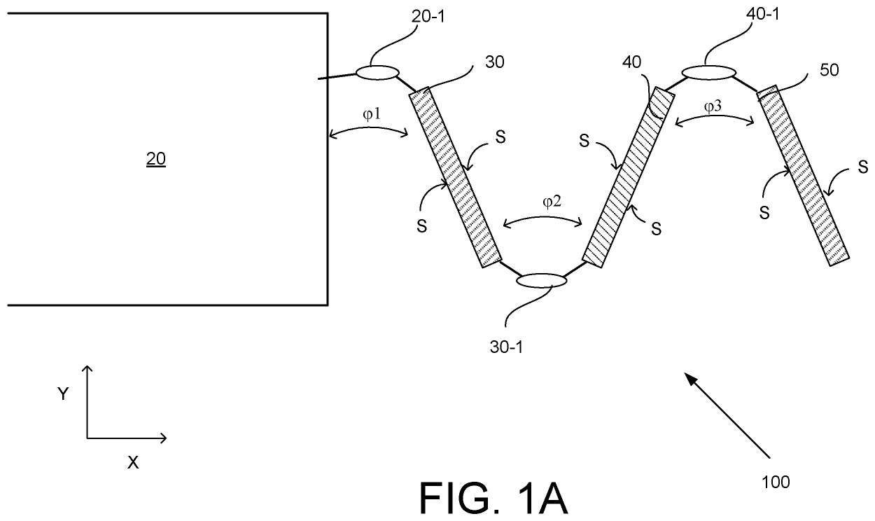

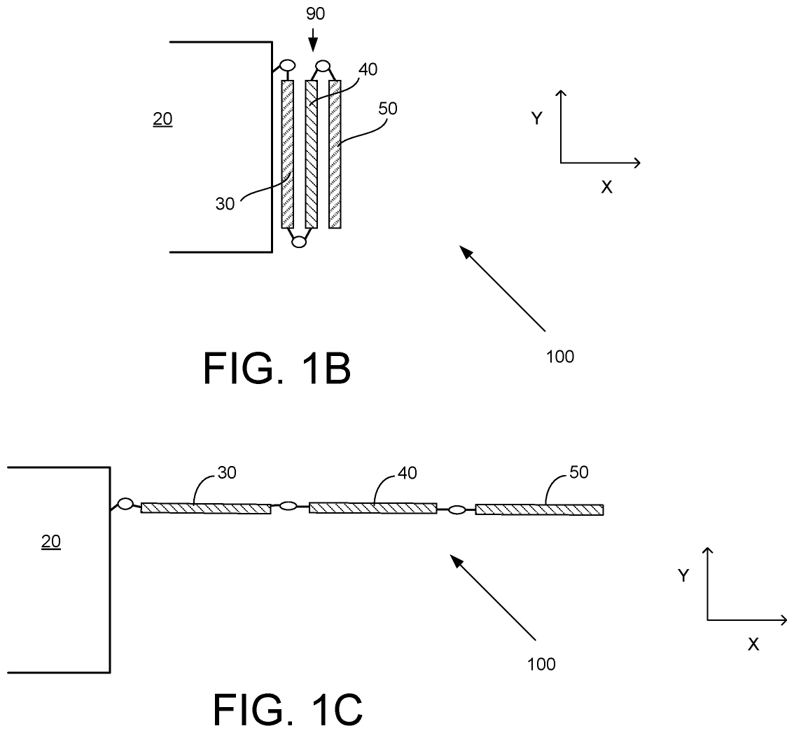

FIG. 1A, FIG. 1B, and FIG. 1C are schematic illustrations, in cross sectional views, of an example foldable multi-panel radiator assembly 100 that may be used to radiatively cool an object (e.g., a spacecraft component 20). Multi-panel radiator assembly 100 may be thermally coupled, for example, by a thermally-conductive hinge (e.g., hinge 20-1) to the object (e.g., spacecraft component 20).

Example foldable multi-panel radiator assembly 100 may include one or more (e.g., three) thermally connected radiator panels (e.g., radiator panel 30, radiator panel 40, and radiator panel 50, etc.). In example implementations, the three radiator panels may be thermally connected in series or in parallel to spacecraft component 20 by flexible thermally-conductive hinges. For example, a base radiator panel (e.g., radiator panel 30) may be thermally connected to spacecraft component 20 by a flexible thermally-conductive hinge 20-1. An auxiliary radiator panel (e.g., radiator panel 40) may be connected by a flexible thermally-conductive hinge 30-1 to radiator panel 30, and another auxiliary radiator panel (e.g., radiator panel 50) may be connected by a flexible thermally-conductive hinge 40-1 to radiator panel 40.

In the example shown in FIG. 1A, foldable multi-panel radiator assembly 100 is depicted in a partially un-folded state, with radiator panel 30 disposed at an angle φ1 with respect to spacecraft component 20; radiator panel 40 disposed at an angle φ2 with respect to radiator panel 30; and radiator panel 50 disposed at an angle φ3 with respect to radiator panel 40. Waste heat generated at spacecraft component 20 may travel (conduct) across the flexible thermally-conductive hinges (e.g., hinges 20-1, 30-1, 40-10) in series to be progressively radiated out into the space environment from surfaces S of the radiator panels (e.g., radiator panels 30, 40 and 50).

In the example shown in FIG. 1B, foldable multi-panel radiator assembly 100 is depicted in a collapsed or fully folded state (in other words in a fully stowed configuration). FIG. 1B shows, for example, radiator panels 30, 40 and 50 positioned, one over another, in a stack 90, for example, on a side of spacecraft component 20.

In the example shown in FIG. 1C, foldable multi-panel radiator assembly 100 is depicted in a fully un-folded or expanded state. FIG. 1C shows, for example, radiator panels 30, 40 and 50, all extended parallel to each other in a sequence along the X axis perpendicular to spacecraft component 20.

The radiative cooling power of radiator assembly 100 in the various folded, partially un-folded, or unfolded states may be proportional to the areas of the surfaces S of the radiative panels that have an unobstructed view of the space environment. Thus, radiator assembly 100 as depicted in the fully un-folded or expanded state in FIG. 1C may correspond to a maximum radiative cooling power state, and radiator assembly 100 as depicted in the collapsed or fully folded state in FIG. 1B may correspond to a minimum radiative cooling power state. Radiator assembly 100 as depicted in the partially un-folded state shown in FIG. 1A may correspond to an intermediate radiative cooling power state (i.e., a cooling power state between the maximum and minimum radiative cooling power states of FIGS. 1B and 1C).

A radiative cooling power of the foldable multi-panel radiator assembly (e.g., radiator assembly 100) in either the folded, partially un-folded, or unfolded states may be proportional to both the total surface area of the radiator panels (e.g., 6×S) and the relative angles (e.g., angle φ1, angle φ2, angle φ3 between the pairs of adjacent panels.

Heat from the object (e.g., spacecraft component 20) is either emitted as thermal radiation directly from the surface of the object into space, or is transferred via heat conduction through the thermally-conductive hinge (e.g., thermally-conductive hinge 20-1) into the base radiator panel (e.g., radiator panel 30) of radiator assembly 100. The heat transferred into the base panel is then emitted as thermal radiation from the base radiator panel surfaces or is transferred to an auxiliary radiator panel (e.g., radiator panel 40) that might be connected to the base radiator panel through flexible thermally-conductive hinges (e.g., thermally-conductive hinge 30-1). Heat transferred into the auxiliary radiator panels is similarly emitted as thermal radiation from auxiliary panel surfaces or is conducted into further adjacent auxiliary panels (e.g., radiator panel 50).

While positioned in the fully un-folded configuration (FIG. 1C), most heat emitted as radiation form the radiator panels escapes from radiator assembly 100, causing excess heat (waste heat) to be removed from the system. Conversely, in a fully folded configuration (FIG. 1C) or in a partially stowed or folded configuration (FIG. 1B), most heat emitted as thermal radiation from a radiator panel may be intercepted by an adjacent radiator panel. A portion of this intercepted heat can be reabsorbed by the adjacent radiator panel while the other portion is reflected, which additionally may be again intercepted by another adjacent radiator panel. As a result of the interceptions and reabsorptions of radiated heat, less total heat is rejected into the space environment when radiator assembly 100 is in the fully stowed or folded configuration (FIG. 1B) as compared to when radiator assembly 100 is in the fully extended or un-folded configuration (FIG. 1C). Controlling the position and orientation of radiator assembly 100 in real time may therefore allow for control of the amount of heat rejected from the object and enable dynamic control of the object's temperature.

In example implementations, the radiator panels (e.g., radiator panel 30, radiator panel 40 and radiator panel 50, etc.) and the flexible thermally-conductive hinges (e.g., hinges 20-1, 30-1 and 40-1) may be made of thermally-conductive materials such as metals or metal alloys. The radiative cooling power of radiator assembly 100 may be a function of the emissivity of the radiative surfaces (e.g., surfaces S of the radiator panels), which may be determined by the type of metal or metallic alloy used in the construction of radiator assembly 100. In some example implementations, the radiative surfaces may be coated with coatings (i.e., paints) having a lower surface absorptivity and a higher emissivity than that of the underlying metal or metallic alloy. In some example implementations, the radiative surfaces (e.g., surfaces S of the radiator panels) may be further prepared with thermochromic or electrochromic materials. The thermochromic or electrochromic materials may exhibit control of radiative surface properties through variations in surface chemistry via a change in temperature or voltage, respectively. The thermochromic or electrochromic materials may be used, for example, to increase the turndown ratio (i.e., the operational range between the maximum and the minimum radiative cooling power) of the foldable radiator assembly.

While orbiting the earth, a spacecraft experiences significant variation in external heat flux. In an extreme external heating case, a spacecraft receives direct solar heating, as well as albedo and infrared radiation from the earth. Alternatively, an extreme cold case occurs when the spacecraft is positioned in the umbra of the earth without direct solar heating or albedo radiation. For spacecraft orbiting the moon, the variations can be even more pronounced due to the presence or absence of albedo and infrared radiation from the moon and earth. Further, instruments in the spacecraft may be turned on periodically, generating large amounts of waste heat at different times. The only way to cool, i.e., remove heat from a spacecraft, is by radiating heat into space. There can be large variations in the amount of waste heat (i.e., the thermal load) that must be removed to cool the spacecraft and maintain it at acceptable temperatures.

Radiator assembly 100 may be dynamically placed in different radiative cooling power states (i.e., in the various folded, partially un-folded, or unfolded states) to match the variations in the amount of waste heat (i.e., the thermal load) that must be removed to cool the spacecraft and maintain it at acceptable temperatures.

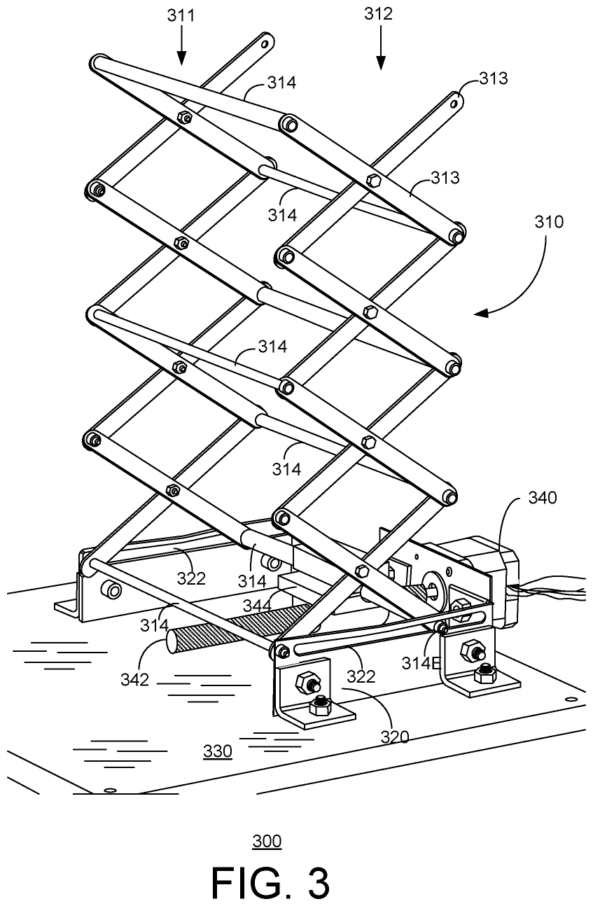

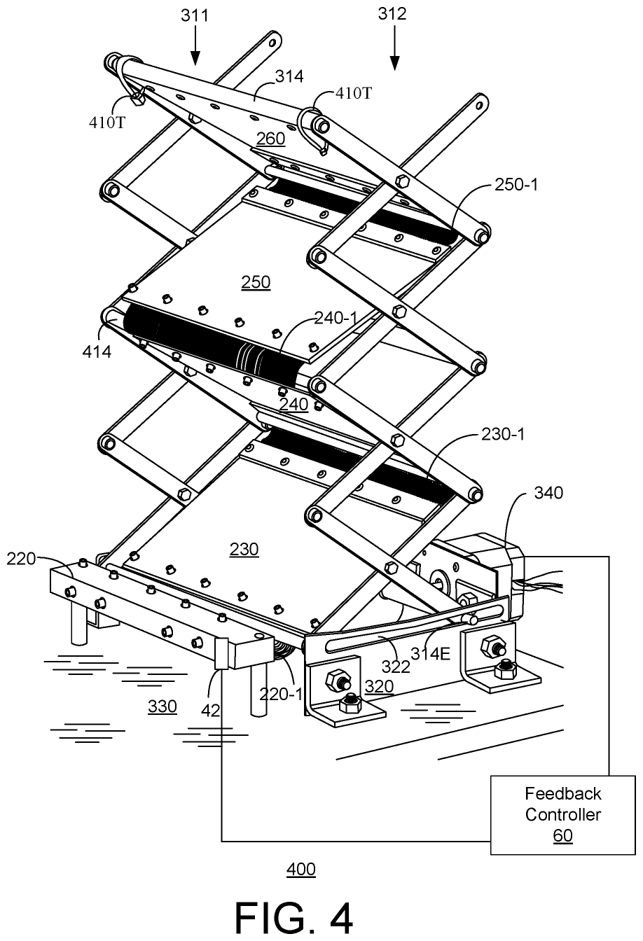

For visual clarity, an actuation mechanism that may be used to dynamically fold or unfold radiator assembly 100 is not shown in FIGS. 1A, 1B or 1C. However, an actuation mechanism that may be used actively with radiator assembly 100 (or other foldable radiator assemblies) is described later herein with reference to FIGS. 3 and 4.

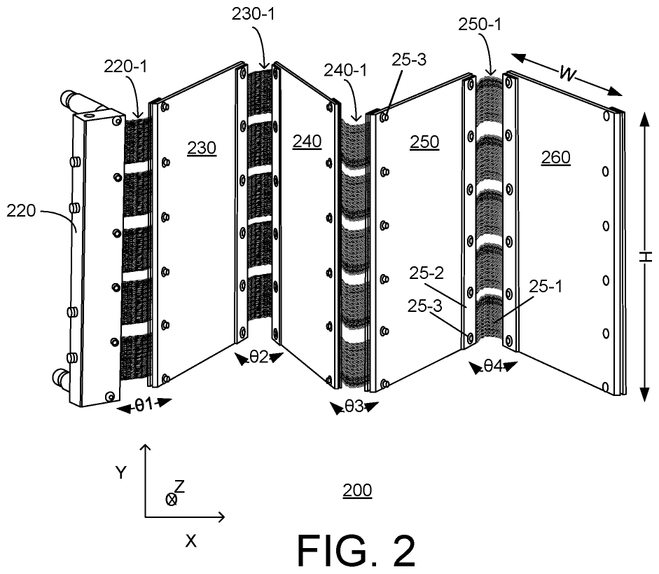

FIG. 2 is schematic illustration, in perspective view, of another example foldable multi-panel radiator assembly 200 that may be thermally coupled, for example, by a thermally-conductive hinge (e.g., hinge 220-1) to an object (e.g., a spacecraft component 220).

Example radiator assembly 200 may include one or more (e.g., four) thermally connected radiator panels (e.g., radiator panel 230, radiator panel 240, radiator panel 250, and radiator panel 260, etc.). The radiator panels may, for example, be rectangular pieces of metal or metal alloy (e.g., aluminum or aluminum alloy). A rectangular radiator panel (e.g., radiator panel 250) may have a width W and a height H). In example implementations, the radiator panels may be about 16 cm wide and 10.2 cm long, with a thickness of 3.5 mm. The radiator panels may be coated on both sides with a paint (e.g., AZ-93 paint, a spectrally selective coating with an emittance in the infrared band of 0.91 and an absorptance in the solar band of 0.15).

In example implementations, the four radiator panels may be thermally connected in series to spacecraft component 220 by flexible thermally-conductive hinges. For example, a base radiator panel (e.g., radiator panel 230) may be thermally connected to spacecraft component 220 by a flexible thermally-conductive hinge 220-1. Radiator panel 230 may be connected by a flexible thermally-conductive hinge 230-1 to an auxiliary radiator panel (e.g., radiator panel 240); radiator panel 240 may be connected by a flexible thermally-conductive hinge 240-1 to another auxiliary radiator panel (e.g., radiator panel 250); and radiator panel 250 may be connected by a flexible thermally-conductive hinge 250-1 to yet another auxiliary radiator panel (e.g., radiator panel 260).

In example implementations, the flexible thermally-conductive hinges (e.g., hinges 220-1, 230-1, 240-1, 250-1) may be made of flexible metal straps (e.g., braided or woven wire straps). In example implementations, the metal straps (e.g., strap 25-1) may, for example, be nickel-coated, copper grounding straps measuring about 8 mm in width and 1 mm in thickness. A bottom side of the metal straps (e.g., strap 25-1) may be epoxied to one side of each radiator panel (e.g., an aluminum panel) using a thermal epoxy (not shown), and a top side of the metal straps (e.g., strap 25-1) may be epoxied to an aluminum pressure plate (e.g., plate 25-2), which is riveted (using e.g., rivets 25-3) to the radiator panel.

In the example shown in FIG. 2, foldable multi-panel radiator assembly 100 is depicted in a partially un-folded state, with radiator panel 230 disposed at an angle θ1 with respect to spacecraft component 220; radiator panel 240 disposed at an angle θ2 with respect to radiator panel 230; radiator panel 250 disposed at an angle θ3 with respect to radiator panel 240; and radiator panel 260 disposed at an angle θ4 with respect to radiator panel 250. Waste heat generated at spacecraft component 220 may travel (conduct) across the flexible thermally-conductive hinges (e.g., hinges 220-1, 230-1, 240-1, and 250-1) in series to be progressively radiated out into the space environment in sequence from surfaces S of the radiator panels (e.g., radiator panels 230, 240, 250 and 260). The amount of heat loss (i.e., heat radiated out) from each of the radiator panels may depend on the position and orientation of the radiative surfaces of the panel.

In some example implementations, the foldable multi-panel radiator assemblies described herein may include, or be integrated with, actively powered mechanical positioners (e.g., motorized actuation mechanisms) that can controllably expand or contract (i.e., unfold or fold) the radiator panel assemblies (e.g., radiator assembly 100, radiator assembly 300) between fully folded, partially un-folded states, and fully un-folded states, to dynamically achieve different levels of radiative power cooling to match variations in the amount of waste heat (i.e., the thermal load) that must be removed to cool the spacecraft and maintain it at acceptable temperatures. The actuation mechanism may utilize one or more mechanical devices (e.g., pulleys, gears, push or pull rods, worm screws, levers, scissor mechanisms, and slider mechanisms, etc.) to guide movement of a radiator panel from one position or orientation to a second position or orientation.

FIG. 3 illustrates an example actuation mechanism 300 that can be integrated with radiator assembly 200. Actuation mechanism 300 may be used to dynamically fold and unfold the foldable radiator panels of the assembly to achieve, for example, different levels of radiative cooling power.

Actuation mechanism 300 may, for example, include a collapsible or foldable frame 310 to which the foldable radiator panels of the assembly (e.g., radiator assembly 200) can be attached. In example implementations, foldable frame 310 (which may have a general appearance of a common expandable accordion-style laundry drying rack) may include two articulating strut assemblies 311, 312 that each form a scissoring mechanism. Strut assemblies 311 and 312 may, for example, each include a number (e.g., eight) of identical struts 313 arranged in a repeating ‘X’ pattern to form the scissoring mechanism.

Struts 313 may, for example, be made of aluminum. In an example implementation, each strut 313 may, for example, be about 13.4 cm long, 1 cm wide and 1.6 mm thick.

In an example implementations, thermally insulated rods 314 may connect the two strut assemblies. Each thermally insulated rod 314 may connect a first strut 313 in strut assembly 311 and a second strut 313 in strut assembly 312.

In example implementations, a base support structure 320 may secure the two strut assemblies 311 and 312 to a base plate 330. Of the four struts 313 at the bottom of both scissoring mechanisms (i.e., strut assemblies 311 and 312), one pair of struts 313 may be secured on base support structure 320 so that they (the pair of struts 313) can rotate about an axis but are unable to translate in any direction. Further, base support structure 320 may include slider slots 322 in which ends 314E of thermally insulated rod 314 connecting the other pair of struts 313 can slide. As ends 314E of thermally insulated rod 314 (slider rod) move along slot 322 away from the secured strut location, the two articulating strut assemblies 311, 312 collapse downward until foldable frame 310 reaches a fully collapsed state (not shown). If the thermally insulated rod 314 (slider rod) is moved toward the secured strut location, foldable frame 310 extends upwards until it reaches a fully extended state. In example implementations, movement of ends 314E of thermally insulated rod 314 (slider rod) along slot 322 may be achieved using an arrangement of a leadscrew 342 and a nut 344 (e.g., an American Corps of Mechanical Engineering (ACME) screw and acme nut arrangement) attached to the slider rod. Leadscrew 342 may be driven by a motor 340 (e.g., a vacuum-rated stepper motor) to reversibly step foldable frame 310 through different positions of expansion and collapse.

FIG. 4 shows an example multi-panel radiator assembly 400 that is obtained by integrating actuation mechanism 300 of FIG. 3 with radiator assembly 200 of FIG. 2.

In example implementations, to integrate actuation mechanism 300 with radiator assembly 200, the thermally insulated rods (e.g., thermally insulated rods 314 connecting strut assembly 311 and strut assembly 313 in foldable frame 310) may be used to secure the radiator panels (e.g., radiator panel 230, radiator panel 240 and radiator panel 250, and radiator panel 260, etc.) to actuation mechanism 300.

Radiator assembly 200 may be connected to actuation mechanism 300, for example, by attaching radiator panel 260 to the top-most thermally insulated rods 314 using, for example, an adhesive (not shown) or vacuum-rated zip ties 410T.

The radiator panels (e.g., radiator panel 230, radiator panel 240 and radiator panel 250, and radiator panel 260, etc.) may be then woven throughout foldable frame 310 such that each flexible thermally-conductive hinge (e.g., hinge 220-1, hinge 230-1, 240-1, 250-1) of radiator assembly 200 is wrapped around the outside of a corresponding thermally insulated rod 314 in foldable frame 310.

In example implementations, an insulating sleeve 414 (e.g., a fiberglass laminate) may be sheathed over each of the connecting thermally insulated rods 314 to prevent heat conduction between the hinges (e.g., hinge 220-1, hinge 230-1, 240-1, 250-1) of radiator assembly 200 and foldable frame 310 of the actuation mechanism.

Radiator assembly 400 (including activation mechanism 300) may include a feedback controller circuit 50 to drive motor 340 or other actively powered mechanical positioners to dynamically step foldable frame 310 through different positions of expansion and collapse in proportion to a temperature of the object (e.g., a spacecraft component 220) to be radiatively cooled. The temperature of spacecraft component 220 may be obtained, for example, by a sensor 42 (e.g., a thermocouple) attached to spacecraft component 220.

When the temperature of the object is increasing, motor 340 may in response step foldable frame 310 toward a more unfolded position to increase the radiative cooling power of radiator assembly 400 available for removing heat from the spacecraft. When the temperature of the object is decreasing, motor 340 may step foldable frame 310 toward a more folded position to decrease the radiative cooling power of radiator assembly 400 available for removing heat from the spacecraft.

In some example implementations, motor 340 may unfold or fold foldable frame 310 in steps in response to variations in thermal load (as indicated by the measured temperature of spacecraft component 220). In some example implementations, motor 340 may fold foldable frame 310 in steps to achieve minimum angles (e.g., angles θ1, θ2, θ3, and θ4, FIG. 2) of about 10° between neighboring radiator panels (e.g., in a collapsed state of foldable frame 310 when the thermal load is small). Motor 340 may unfold foldable frame 310 in steps to achieve maximum angles of about 175° between neighboring radiator panels (e.g., in a fully-un-folded state of foldable frame 310 when the thermal load is larger).

The radiator assemblies (e.g., radiator assembly 100, 200, and 400) described in the foregoing are functionalized to radiate heat entirely by variations in geometry of the presentations of the radiative surfaces (e.g., surfaces of panels 230, 240, 250, and 260, etc.). The variations in geometry (i.e., position and orientation) vary the effective emitting radiative surface area presented to the surrounding space environment and thus result in variations in the radiative cooling power of the radiator assembly.

The described radiator assemblies may be constructed from simple, inexpensive materials. As such, the technology can be easily and economically scaled to match the heat transfer requirements of any spacecraft.

In example implementations, the surfaces (e.g., the surfaces of panels 230, 240, 250, and 260) in a radiator assembly deployed for radiative cooling may be combined and enhanced with other radiative heat transfer control techniques that may, for example, utilize non-geometric mechanisms. For example, an actively or passively controlled deployable radiator surface of a radiator assembly may be coated with a thermochromic or electrochromic coating. Such a radiator assembly can utilize the geometric variations of emitting radiative surface areas as well as the non-geometric variations of intrinsic properties of the radiative surfaces for radiative cooling. Acting in parallel to the geometric variations in the emitting radiative surface areas, the non-geometric radiative heat transfer control mechanisms (e.g., thermochromic or electrochromic coating) may increase a total turn-down ratio potential of the radiator assembly.

The actively-controlled radiator assemblies (e.g., radiator assembly 100, 200, and 400) described in the foregoing utilize geometric presentations (i.e., positions and orientations) of multiple radiator panels that are thermally connected in series to control heat loss (of heat from a heat-generating object (e.g. a spacecraft component)). Heat from the heat-generating object passes through the multiple radiator panels sequentially, one-by-one, in series. The position and orientation of the multiple radiator panels can be actively controlled to control a sequential radiative heat loss from each of the multiple radiator panels.

In the radiator assemblies (e.g., radiator assembly 100, 200, and 400), a single panel (e.g., a radiator panel referred to as “base radiator panel,” panel 30 FIG. 1A, panel 230 FIG. 2) is physically and thermally connected to the object that is to be thermally cooled via a flexible thermally conductive hinge (e.g., hinge 20-1). Additional radiator panels (auxiliary radiator panels, e.g., panels 40 and 50, FIG. 1A, panels 240 and 250, FIG. 2)) are physically and thermally connected in series via flexible thermally conductive hinges (e.g., hinges 30-1, 40-1, etc.) to the base radiator panel forming a one-dimensional sequence or lattice of radiator panels. Each connection between the inter-connected auxiliary panels or between a base panel and the object may include a flexible thermally-conductive hinge (e.g., hinge 20-1, FIG. 1A). In an example implementation, the flexible thermally-conductive hinges may be made of interwoven copper wires that are secured to adjacent surfaces of each connected panel. In other example implementations, the flexible thermally-conductive hinge may be made of flexible oscillating heat pipes or flexible heat straps made of copper, aluminum or graphite.

In further implementations, a foldable radiator assembly may include one or more base radiator panels that are each physically and thermally connected to the object that is to be thermally cooled. The one or more base radiator panels may have any geometric shape (e.g. triangular, rectangular, trapezoidal, etc.). In some example implementations, the one or more base radiator panels may include one to four triangle-shape radiator panels, or one to two rectangle-shape radiator panels. In some example implementations, the one or more base radiator panels (e.g., four triangle-shape base radiator panels, or two rectangle shape base radiator panels) may form a complete tessellation or tiling of a flat surface in a folded state of the radiator assembly.

In some example implementations, the one or more base radiator panels may be connected to respective one or more auxiliary panels. In some example implementations, at least one of the one or more base radiator panels may be without a connected auxiliary panel or may be connected to a respective one or more auxiliary panels. The one or more base radiator panels (and associated auxiliary panels) may form a complete tessellation or tiling of the flat surface in a folded state of the radiator assembly.

In some example implementations, the multiple base radiator panels may not be inter-connected so that each base radiator panel and its associated auxiliary radiator panels operate independently from other base radiator panel/auxiliary radiator panel sequences or lattices. Each sequence or lattice of a base radiator panel and associated auxiliary radiator panels (or an entire tessellation or tiling of a flat surface when all panels are inner-connected) may be physically secured either to the object or to a designated structural support that may include inter-connected rigid struts or a system of cables and tensioning rods.

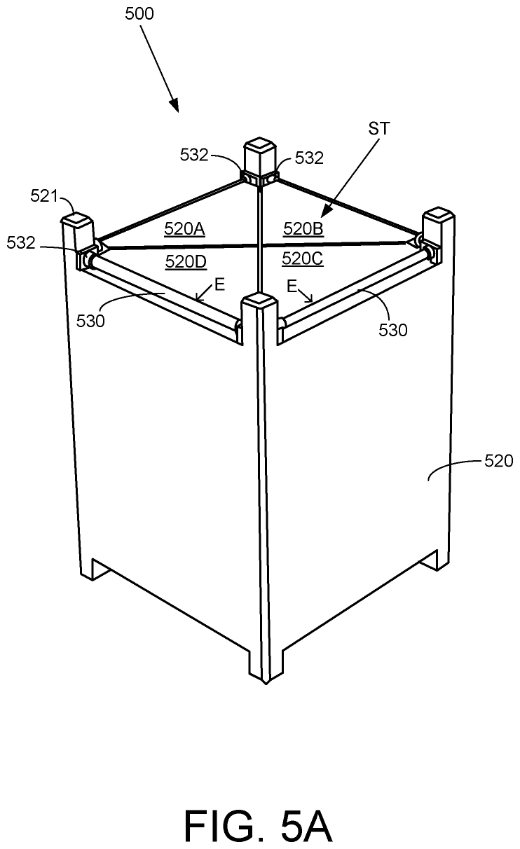

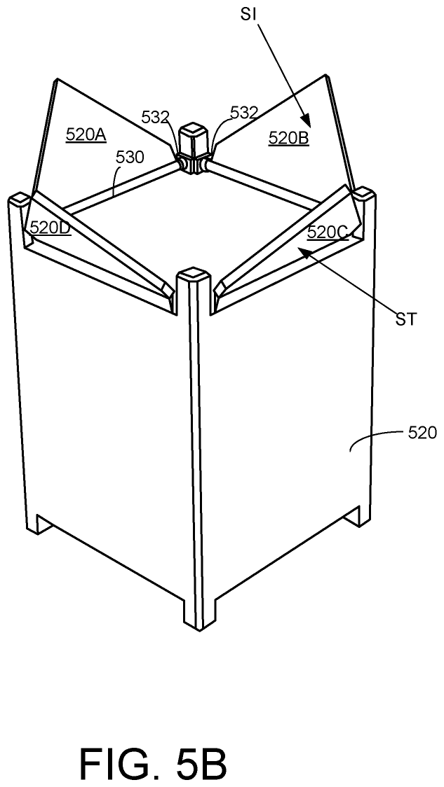

FIG. 5A and FIG. 5B illustrate, in perspective views, a foldable multi-panel radiator assembly 600 disposed on or in a spacecraft enclosure 620. The spacecraft enclosure may, for example, be a small satellite or a pico satellite enclosure or container such as a CubeSat unit container (e.g., a 10 cm×10 cm×10 cm container unit).

A bi-metallic coil is made of two sheets of metals with different coefficients of thermal expansion bonded together. As the coil heats up, the metals expand at different rates, causing the coil to deflect, i.e., curl or uncurl, depending on the coil's configuration. When the coil cools, it relaxes and returns to the undeflected state. Foldable multi-panel radiator assembly 600 may be deployed using a passive actuation mechanism such as a bi-metallic temperature-responsive positioner as a means to fold or unfold panels in radiator assembly 600.

As shown in FIG. 5A, radiator assembly 500 may include four foldable radiator panels (e.g., radiator fins 500A, 500B, 500C and 500D). The four foldable radiator panels may, for example, have a triangle shape. In a fully folded state of radiator assembly 500, the four triangle-shape radiator panels may make a one complete tessellation or tiling of an external surface (e.g., a top surface ST) of spacecraft enclosure 520 (e.g. a CubeSat unit container). Each of the four foldable radiator panels (e.g., radiator fins 500A, 500B, 500C and 500D) may be attached to a conductive rod/hinge 530 having a bi-metallic coil 532 at each end of the rod. FIG. 5A shows, for example, a triangle side or edge E of each of the triangular shape radiator fins (e.g., radiator fins 500A, 500B, 500C and 500D) attached to a respective conductive rod/hinge 530. One end of each bi-metallic coil 532 may be attached to a corner frame post 521 of spacecraft enclosure 520, while the other end of each bi-metallic coil 532 may be attached to conductive rod/hinge 530. As the temperature of bi-metallic coils 532 increases, the coils may curl and rotate conductive rod/hinges 530 (and attached radiator fins) to deploy the radiator panels, for example, in an open position. FIG. 5B shows, for example, the four foldable radiator panels (e.g., radiator fins 500A, 500B, 500C and 500D) in a fully open position (i.e., in an fully un-folded state of radiator assembly 500). When the temperature of bi-metallic coils 532 decreases, the coils may un-curl and rotate conductive rod/hinges 530 (and attached radiator fins) to move the opened radiator panels back toward a partially unfolded position (not shown) or a fully folded position (FIG. 5A).

In this open position, radiative heat loss from the four foldable radiator panels is increased, reducing the temperature of spacecraft enclosure 520 (e.g. a CubeSat unit container). Heat from spacecraft enclosure 520 may be transferred to the bi-metallic coils 532 via thermal conduction through conductive rod/hinge 530 and frame post 621, as well as by radiation from the interior of the CubeSat unit container to the four foldable radiator panels.

In example implementations, to increase a turndown ratio of radiator assembly 500, internal surfaces SI of the radiator panels may, for example, be coated with a high emissivity paint (e.g., a black paint) while the exterior surfaces ST may be coated with reflective paint (e.g., a white paint).

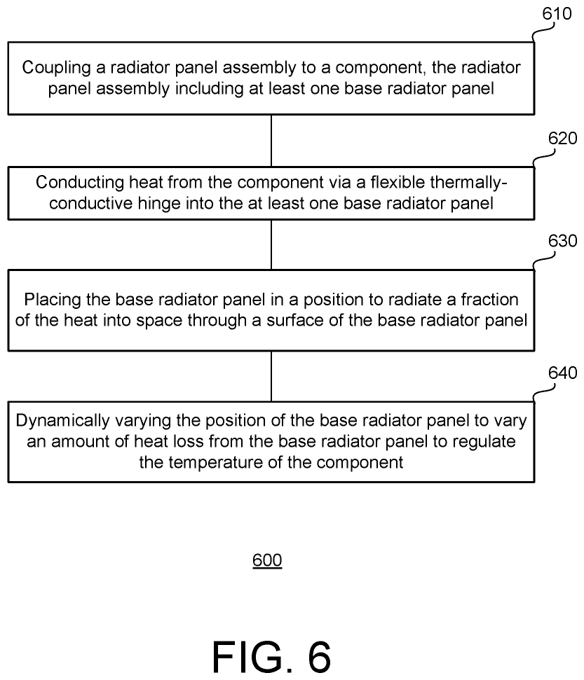

FIG. 6 illustrates a method 600 for regulating temperatures of a component in a spacecraft unit.

Method 600 includes coupling a radiator panel assembly to a component, the radiator panel assembly including at least one base radiator panel (610). The radiator panel assembly can include one or more auxiliary radiator panels that are thermally connected to the at least one base radiator panel. Method 600 further includes conducting heat from the component via a flexible thermally-conductive hinge into the at least one base radiator panel (620), and placing the base radiator panel in a position to the radiate a fraction of the heat into space through a surface of the base radiator panel (630).

The portion or fraction of heat that is radiated into space (in other words, the amount of heat loss) may depend on the position or orientation of the base radiator panel. Method 600 may further include dynamically varying the position or orientation of the base radiator panel to vary an amount of heat loss through the base radiator panel for regulating the temperature of the component (640).

Dynamically varying the position of the base radiator panel 640 may include using an actuation mechanism to deploy the base radiator panel in a selected position based on the temperature of the component.

In example implementations, the actuation mechanism can be a bi-metallic coil thermally coupled to the component and the base radiator panel.

In some example implementations, the actuation mechanism can be a stepper motor responsive to the temperature of the component

Method 600 may further include conducting heat from the at least one base radiator panel into an auxiliary radiator panel coupled to the at least one base radiator panel, and placing the auxiliary radiator panel in a position to the radiate another fraction of the heat into space through a surface of the auxiliary radiator panel.

In the foregoing disclosure, it will be understood that when an element, such as a layer, a region, or a substrate, is referred to as being on, connected to, thermally connected to, coupled to, or thermally coupled to another element, it may be directly on, connected or coupled to the other element, or one or more intervening elements may be present. In contrast, when an element is referred to as being directly on, directly connected to or directly coupled to another element or layer, there are no intervening elements or layers present. Although the terms directly on, directly connected to, or directly coupled to may not be used throughout the detailed description, elements that are shown as being directly on, directly connected or directly coupled can be referred to as such. The claims of the application may be amended to recite exemplary relationships described in the specification or shown in the figures.

As used in this specification, a singular form may, unless definitely indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A method comprising:
coupling a radiator panel assembly to a component, the radiator panel assembly including at least one base radiator panel;
conducting heat from the component via a thermally conductive hinge into the at least one base radiator panel;
placing the at least one base radiator panel in a position to radiate a fraction of the heat into space through a surface of the at least one base radiator panel; and
dynamically varying the position of the at least one base radiator panel to vary an amount of heat loss through the at least one base radiator panel to regulate a temperature of the component.

2. The method of claim 1, wherein dynamically varying the position of the at least one base radiator panel includes using an actuation mechanism to deploy the at least one base radiator panel in a selected position based on the temperature of the component.

3. The method of claim 2, wherein using the actuation mechanism includes using a bi-metallic temperature-responsive positioner thermally coupled to the component and the at least one base radiator panel.

4. The method of claim 2, wherein using the actuation mechanism includes using an actively powered mechanical positioner responsive to the temperature of the component.

5. The method of claim 1, wherein coupling the radiator panel assembly includes coupling a foldable multi-panel radiator assembly including at least one triangle-shape base radiator panel.

6. The method of claim 1, further comprising:
conducting heat from the at least one base radiator panel into an auxiliary radiator panel coupled to the at least one base radiator panel; and
placing the auxiliary radiator panel in a position to radiate another fraction of the heat into space through a surface of the auxiliary radiator panel.

7. The method of claim 6, wherein dynamically varying the position of the at least one base radiator panel includes varying a position of the auxiliary radiator panel to vary an amount of heat loss through the at least one base radiator panel and the auxiliary radiator panel to regulate the temperature of the component.

8. The method of claim 1, wherein coupling the radiator panel assembly includes coupling a foldable multi-panel radiator assembly including one or more auxiliary radiator panels coupled to the at least one base radiator panel, the foldable multi-panel radiator assembly having a fully folded configuration, a fully un-folded configuration, and one or more partially un-folded configurations.

9. The method of claim 8, wherein dynamically varying the position of the at least one base radiator panel includes moving the foldable multi-panel radiator assembly to the fully folded configuration, the fully un-folded configuration, or the one or more partially un-folded configurations for regulating the temperature of the component.

10. The method of claim 8 further comprising sensing the temperature of the component, and wherein moving the foldable multi-panel radiator assembly includes moving the foldable multi-panel radiator to the fully folded configuration, the fully un-folded configuration, or the one or more partially un-folded configurations in a feedback loop responsive to a sensed temperature of the component.

11. A thermal management system, comprising:
a foldable multi-panel radiator assembly including a multiplicity of radiator panels, each radiator panel connected in series or parallel to a neighboring radiator panel by a thermally-conductive hinge, the foldable multi-panel radiator assembly being thermally coupled to a component subjected to varying waste heat loads; and
an actuation mechanism configured to fold, partially unfold, or fully unfold the foldable multi-panel radiator assembly to remove the varying waste heat loads through the radiator assembly.

12. The thermal management system of claim 11, wherein the actuation mechanism is configured to present the radiator panels in different positions and orientations corresponding to different radiative cooling power states of the radiator assembly.

13. The thermal management system of claim 12, wherein in a fully folded configuration, the radiator assembly is in a minimum radiative cooling power state; in a fully un-folded configuration, the radiator assembly is in a maximum radiative cooling power state; and in a partially un-folded configuration, the radiator assembly is in an intermediate radiative cooling power state between the maximum radiative cooling power state and the minimum radiative cooling power state.

14. The thermal management system of claim 11, further comprising a feedback controller circuit configured to drive the actuation mechanism to position the foldable radiator assembly in different radiative cooling power states to obtain the radiative cooling power needed to balance the varying waste heat loads and maintain a temperature of the component.

15. The thermal management system of claim 11, wherein the foldable multi-panel radiator assembly includes at least one base radiator panel coupled to the component by a first thermally-conductive hinge, and at least one auxiliary radiator panel coupled to base radiator panel by a second thermally-conductive hinge.

16. The thermal management system of claim 11, wherein a radiative cooling power of the foldable multi-panel radiator assembly is proportional to both the total surface area of the radiator panels and the relative angles between pairs of adjacent panels.

17. A spacecraft unit, comprising:
a container including a heat generating instrument;
a foldable radiator assembly coupled to the container, the foldable radiator assembly including one or more base radiator panels; and
at least one bi-metallic temperature-responsive positioner coupling at least one of the base radiator panels to the container.

18. The spacecraft unit of claim 17, wherein the one or more base radiator panels forming a complete tessellation of a surface in a folded state of the foldable radiator assembly.

19. The spacecraft unit of claim 18, wherein the at least one bi-metallic temperature-responsive positioner is configured to unfold the at least one of the base radiator panels in response to a change in temperature of the container.

20. The spacecraft unit of claim 18, wherein the container is a CubeSat unit container.
